(19) United States
(12) Patent Application Publication
(10) Pub. No.: US 2026/0139672 A1
(43) Pub. Date: May 21, 2026

(54) SCROLL COMPRESSOR

(71) Applicant: SAMSUNG ELECTRONICS CO., LTD., Suwon-si (KR)

(72) Inventors: Mooseong BAE, Suwon-si (KR); Jongsoo NOH, Suwon-si (KR); Sunghyuk PARK, Suwon-si (KR); Inwon PARK, Suwon-si (KR); Jaesang LEE, Suwon-si (KR); Sungchan CHO, Suwon-si (KR); Yanghee CHO, Suwon-si (KR)

(73) Assignee: SAMSUNG ELECTRONICS CO., LTD., Suwon-si (KR)

(21) Appl. No.: 19/452,738

(22) Filed: Jan. 19, 2026

Related U.S. Application Data
(63) Continuation of application No. PCT/KR2024/007514, filed on May 31, 2024.

(30) Foreign Application Priority Data
Jul. 19, 2023 (KR) 10-2023-0094061

(51) Int. Cl. F04C 18/02

(52) U.S. Cl. CPC F04C 18/0215; F04C 2240/30

(57) ABSTRACT

A scroll compressor including a casing; a main frame including a receiving groove formed on an upper surface of the main frame; a fixed scroll on the upper surface of the main frame; an orbiting scroll arrangeable in the receiving groove of the main frame and engaging with the fixed scroll to form a compression chamber; an axially compliant frame arrangeable in the receiving groove of the main frame, the axially compliant frame being at a lower side of the orbiting scroll, moveable relative to the lower side of the orbiting scroll, and configured to divide the receiving groove into a first back pressure chamber and a second back pressure chamber; a drive shaft coupleable to a lower portion of the orbiting scroll and configured to rotate the orbiting scroll; and a drive motor arrangeable below the main frame and configured to rotate the drive shaft.

### CROSS-REFERENCE TO RELATED APPLICATION

This application is a continuation application, under 35 U.S.C. § 111(a), of international application No. PCT/KR2024/007514, filed May 31, 2024, which claims priority under 35 U.S.C. § 119 to Korean Patent Application No. 10-2023-0094061, filed Jul. 19, 2023, the disclosures of which are incorporated herein by reference in their entireties.

### TECHNICAL FIELD

The disclosure relates to a scroll compressor, and more particularly, to a scroll compressor including a back pressure chamber.

### BACKGROUND ART

A compressor is a mechanical device that increases pressure by compressing air, refrigerant, or various other working gases using a motor, a turbine, or the like. The compressor is used in a variety of ways throughout industries.

When a compressor is used in a refrigerant cycle, it may convert low pressure refrigerant into high pressure refrigerant and deliver it back to a condenser.

Compressors may be broadly classified into a reciprocating compressor that forms a compression space between a piston and a cylinder where a refrigerant is sucked in and discharged and compresses the refrigerant while the piston reciprocates linearly inside the cylinder, a rotary compressor that forms a compression space between an eccentrically rotating rolling piston and a cylinder where a refrigerant is sucked in and discharged and compresses the refrigerant while the rolling piston rotates eccentrically along the inner wall of the cylinder, and a scroll compressor that forms a compression space between an orbiting scroll and a fixed scroll where a refrigerant is sucked in and discharged and compresses the refrigerant while the orbiting scroll rotates relative to the fixed scroll.

The scroll compressors are widely used in the refrigeration cycle devices because they are more efficient, have less vibration and noise, and are compact and light weight compared to the reciprocating compressors or the rotary compressors.

### DISCLOSURE OF INVENTION

### Technical Solution

A scroll compressor according to one or more embodiments of the disclosure may include: a casing; a main frame, fixable inside the casing, comprising a receiving groove that is formed on an upper surface of the main frame; a fixed scroll arrangeable on the upper surface of the main frame; an orbiting scroll arrangeable in the receiving groove of the main frame such that while the orbiting scroll is arranged in the receiving groove, the orbiting scroll is engaged with the fixed scroll to form a compression chamber; an axially compliant frame in the receiving groove of the main frame such that while the axially compliant frame is arranged in the receiving groove, the axially compliant frame is at a lower side of the orbiting scroll and the axially compliant frame is moveable relative to the lower side of the orbiting scroll, the axially compliant frame being configured to divide the receiving groove into a first back pressure chamber and a second back pressure chamber; a drive shaft, coupleable to a lower portion of the orbiting scroll, configured to rotate the orbiting scroll; and a drive motor, arrangeable below the main frame, configured to rotate the drive shaft.

According to one or more embodiments of the disclosure, the first back pressure chamber may be located inside the axially compliant frame, and the second back pressure chamber may be located outside the axially compliant frame.

According to one or more embodiments of the disclosure, the first back pressure chamber and the second back pressure chamber may be isolated from each other by a first seal between an upper surface of the axially compliant frame and a lower surface of the orbiting scroll at the lower side of the orbiting scroll, and a second seal between an outer circumferential surface of the axially compliant frame and the main frame.

According to one or more embodiments of the disclosure, the axially compliant frame may include a first sealing groove formed on the upper surface of the axially compliant frame to accommodate the first seal; and a second seal groove formed on the outer circumferential surface of the axially compliant frame to accommodate the second seal.

According to one or more embodiments of the disclosure, the first sealing groove may have a height of an inner wall in contact with the first back pressure chamber lower than a height of an outer wall in contact with the second back pressure chamber.

According to one or more embodiments of the disclosure, the first sealing groove may have a height of an outer wall in contact with the second back pressure chamber lower than a height of an inner wall in contact with the first back pressure chamber.

According to one or more embodiments of the disclosure, the orbiting scroll may include a first intermediate pressure passage connecting the compression chamber and the first back pressure chamber; and a second intermediate pressure passage connecting the compression chamber and the second back pressure chamber.

According to one or more embodiments of the disclosure, the first intermediate pressure passage may be formed to connect the upper surface of the lower surface of the orbiting scroll at the lower side of the orbiting scroll.

According to one or more embodiments of the disclosure, the second intermediate pressure passage may be formed to connect the upper surface and the side surface of the orbiting scroll.

According to one or more embodiments of the disclosure, the main frame may include an Oldham ring disposed in the receiving groove of the main frame on the lower side of the orbiting scroll at the lower side of the orbiting scroll. The Oldham ring may be disposed on an outer side of the axially compliant frame.

According to one or more embodiments of the disclosure, a pressure of the first back pressure chamber may be greater than a pressure of the second back pressure chamber.

According to one or more embodiments of the disclosure, the axially compliant frame may include an upper sleeve formed in a hollow cylindrical shape; and a lower sleeve formed in a hollow cylindrical shape extending from a lower surface of the upper sleeve and having an outer diameter smaller than an outer diameter of the upper sleeve and an inner diameter equal to an inner diameter of the upper sleeve. A first seal may be disposed on an upper surface of the upper sleeve, and a second seal may be disposed on an outer circumferential surface of the lower sleeve.

According to one or more embodiments of the disclosure, the first back pressure chamber may be formed as a space between the orbiting scroll and an inner circumferential surface of the axially compliant frame, and the second back pressure chamber may be formed as a space between the orbiting scroll, the receiving groove of the main frame, and an outer circumferential surface of the axially compliant frame.

According to one or more embodiments of the disclosure, the receiving groove of the main frame may include an upper receiving groove in which the upper sleeve is received; and a lower receiving groove formed on a bottom surface of the upper receiving groove to have a smaller diameter than the upper receiving groove and in which the lower sleeve is received.

According to one or more embodiments of the disclosure, a scroll compressor may further include: a lower seal between a lower surface of the orbiting scroll and a bottom surface of the receiving groove of the main frame.

### BRIEF DESCRIPTION OF DRAWINGS

These and/or other aspects, features, and advantages of certain embodiments of the disclosure will be more apparent from the following description taken in conjunction with the accompanying drawings, in which:
FIG. 1 is a perspective view illustrating a scroll compressor according to one or more embodiments of the disclosure.

FIG. 2 is a cross-sectional view illustrating a scroll compressor according to one or more embodiments of the disclosure.

FIG. 3 is an enlarged cross-sectional view illustrating an upper portion of the scroll compressor of FIG. 2 according to one or more embodiments of the disclosure.

FIG. 4 is an exploded perspective view illustrating major components of a scroll compressor according to one or more embodiments of the disclosure.

FIG. 5 is a bottom perspective view illustrating an orbiting scroll of a scroll compressor according to one or more embodiments of the disclosure.

FIG. 6 is a perspective view illustrating an axially compliant frame of a scroll compressor according to one or more embodiments of the disclosure.

FIG. 7 is an enlarged cross-sectional view illustrating portion A of FIG. 3 according to one or more embodiments of the disclosure.

FIG. 8 is a partial cross-sectional view illustrating an orbiting scroll and an axially compliant frame of a scroll compressor according to one or more embodiments of the disclosure.

FIG. 9 is a diagram illustrating a pressure distribution in an orbiting scroll of a scroll compressor according to the prior art.

FIG. 10 is a diagram illustrating a pressure distribution in an orbiting scroll of a scroll compressor according to one or more embodiments of the disclosure.

FIG. 11 is a partial cross-sectional view illustrating a back pressure chamber of a scroll compressor according to the prior art.

### BEST MODE FOR CARRYING OUT THE INVENTION

Various embodiments of this document and terms used herein are not intended to limit the technical features described in this document to specific embodiments, but should be understood to include various modifications, equivalents, or alternatives of the embodiments.

In connection with the description of the drawings, similar reference numbers may be used for similar or related components.

The singular form of a noun corresponding to an item may include one or more of the above item, unless the relevant context clearly indicates otherwise.

In this document, each of phrases such as “A or B,” “at least one of A and B,” “at least one of A or B,” “A, B, or C,” “at least one of A, B, and C,” “at least one of A, B, C” may include any one of the items listed together with the corresponding phrase, or any possible combination thereof.

The term “and/or” includes any element of a plurality of related described elements or a combination of a plurality of related described elements.

Terms such as “first,” “second,” “primary,” or “secondary” may be used simply to distinguish one component from other components, and do not limit the corresponding components in other respects (e.g., importance or order).

When it is mentioned that one (e.g., first) component is “coupled” or “connected” to another (e.g., second) component with or without terms “functionally” or “communicatively”, it means that the one component can be connected to the another component directly (e.g., wired), wirelessly, or through a third component.

Terms such as “include” or “have” are intended to designate the presence of features, numbers, steps, operations, components, parts, or combinations thereof described in the embodiment, but do not preclude the presence or addition of one or more other features, numbers, steps, operations, components, parts, or combination thereof.

When a component is said to be “connected,” “coupled,” “supported,” or “in contact” with another component, this means not only cases where the components are directly connected, coupled, supported, or contacted, but also cases where the components are indirectly connected, coupled, supported, or contacted through a third component.

When a component is said to be located “on” other component, this includes not only cases where the component is in contact with the other component, but also cases where another component exits between the two components.

Further, the terms ‘leading end’, ‘rear end’, ‘upper side’, ‘lower side’, ‘top end’, ‘bottom end’, etc. used in the disclosure are defined with reference to the drawings. However, the shape and position of each component are not limited by the terms.

The disclosure relates to a scroll compressor capable of reducing friction loss and axial refrigerant leakage.

Hereinafter, a scroll compressor 1 according to one or more embodiments of the disclosure will be described in detail with reference to the accompanying drawings.

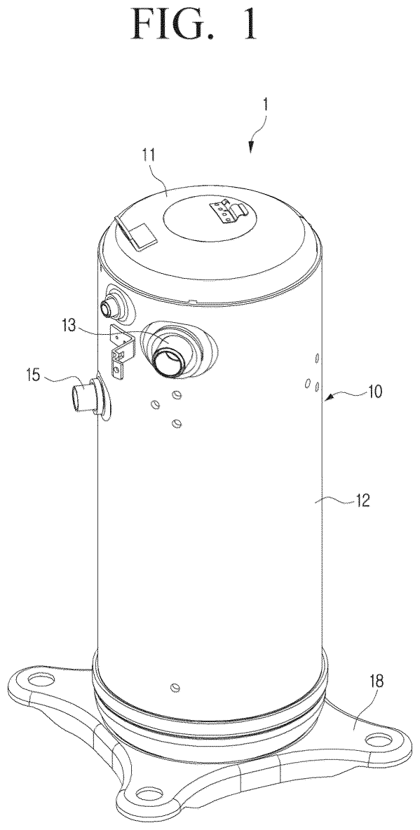

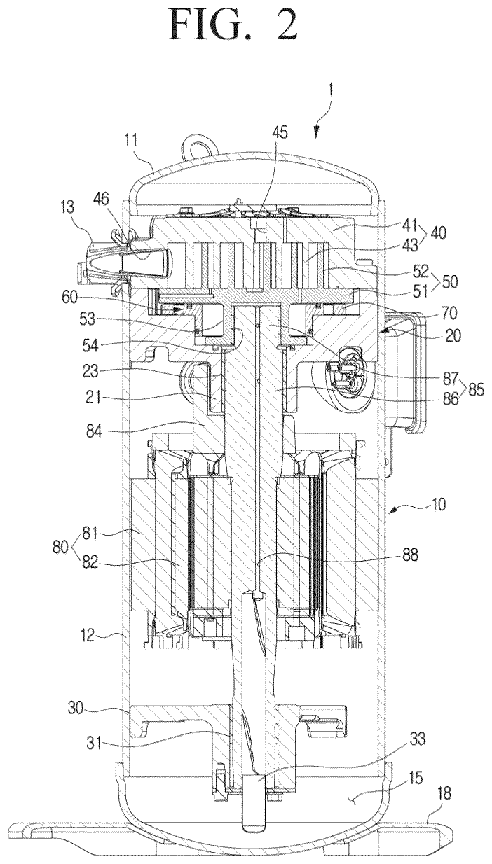

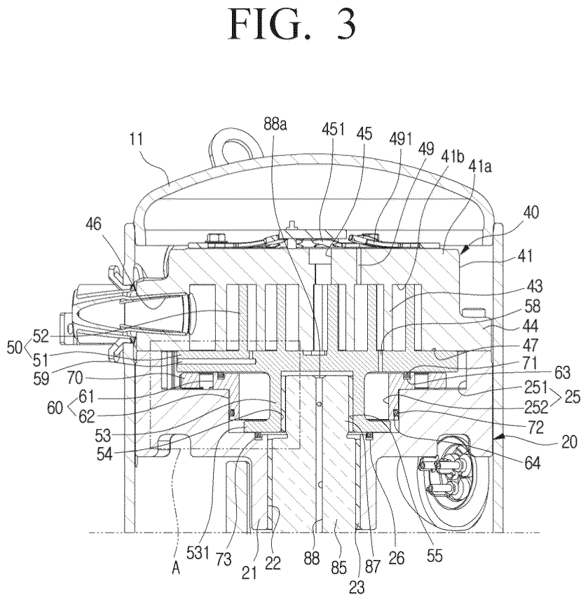

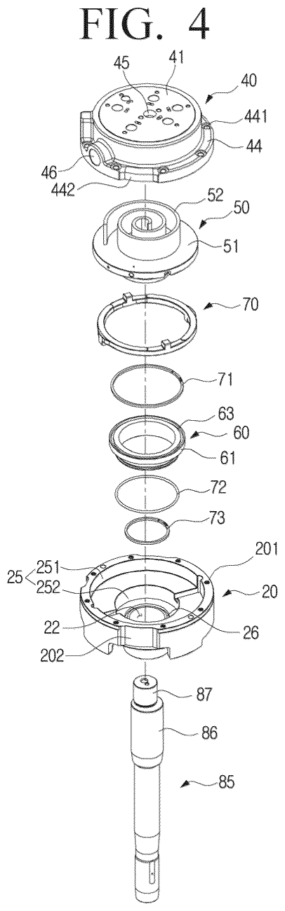

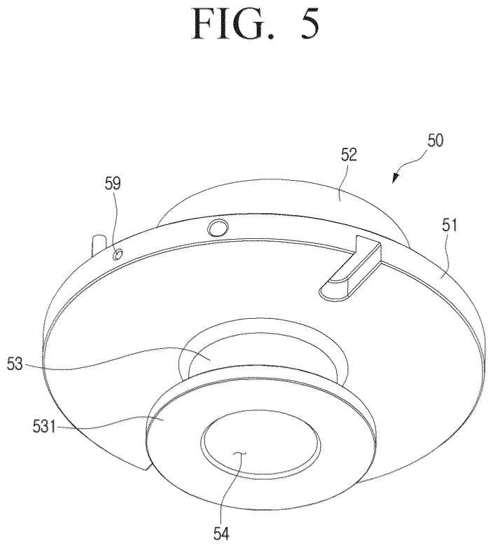

FIG. 1 is a perspective view illustrating a scroll compressor 1 according to one or more embodiments of the disclosure. FIG. 2 is a cross-sectional view illustrating a scroll compressor 1 according to one or more embodiments of the disclosure. FIG. 3 is an enlarged cross-sectional view illustrating an upper portion of the scroll compressor 1 of FIG. 2. FIG. 4 is an exploded perspective view illustrating major components of a scroll compressor 1 according to one or more embodiments of the disclosure. FIG. 5 is a bottom perspective view illustrating an orbiting scroll 50 of a scroll compressor 1 according to one or more embodiments of the disclosure.

Referring to FIGS. 1 to 4, a scroll compressor 1 according to one or more embodiments of the disclosure may include a casing 10, a main frame 20, a sub frame 30, a fixed scroll 40, an orbiting scroll 50, an axially compliant frame 60, and a drive motor 80.

The casing 10 may be a cylindrical sealed container and may include an upper casing 11 and a lower casing 12. The casing 10 may house the main frame 20, the sub frame 30, the fixed scroll 40, the orbiting scroll 50, the axially compliant frame 60, and the drive motor 80.

The casing 10 may be provided with a refrigerant inlet pipe 13 through which refrigerant is introduced and a refrigerant discharge pipe 15 through which refrigerant is discharged.

The refrigerant inlet pipe 13 may penetrate the casing 10 and have one end connected to the fixed scroll 40. The refrigerant discharge pipe 15 may penetrate the casing 10, and have one end communicating with the inside of the casing 10.

Therefore, refrigerant may flow into the fixed scroll 40 disposed in the casing 10 through the refrigerant inlet pipe 13, and compressed refrigerant discharged from the fixed scroll 40 may be discharged to the outside of the casing 10 through the refrigerant discharge pipe 15.

A base 18 supporting the casing 10 may be provided at the bottom of the lower casing 12. The scroll compressor 1 may be disposed vertically with respect to the support surface by the base 18.

The main frame 20 and the sub frame 30 may be spaced apart vertically by a certain distance. The main frame 20 and the sub frame 30 may be fixed inside the casing 10. The drive motor 80 that rotates the orbiting scroll 50 may be disposed between the main frame 20 and the sub frame 30.

The fixed scroll 40 and the orbiting scroll 50 may be disposed on the upper side of the main frame 20. An oil reservoir 15 containing oil or lubricant for lubricating and cooling components accommodated inside the casing 10 may be provided below the sub frame 30 in a lower portion of the casing 10.

The main frame 20 may be formed in a substantially circular plate shape. A protrusion 21 may be formed on the lower surface of the main frame 20. A shaft support hole 22 may be formed in the protrusion 21 of the main frame 20. A bearing 23 supporting a drive shaft may be disposed in the shaft support hole 22. The bearing 23 may be formed of bearing metal.

The drive shaft 85 may be inserted through the bearing 23, so that the bearing 23 may support the rotation of the drive shaft 85.

A receiving groove 25 may be provided on the upper surface of the main frame 20. The receiving groove 25 may be formed to accommodate the orbiting scroll 50 and the axially compliant frame 60. The receiving groove 25 may be formed as circular cross-section groove.

The receiving groove 25 may be formed in two stages. In detail, the receiving groove 25 may include an upper receiving groove 251 and a lower receiving groove 252.

The upper receiving groove 251 may be formed at a certain depth on the upper surface of the main frame 20. The upper receiving groove 251 may be formed to have a circular cross-section. The lower receiving groove 252 may be formed at a certain depth on the bottom surface of the upper receiving groove 251. The lower receiving groove 252 may be formed to have a circular cross-section with a smaller diameter that the upper receiving groove 251. Accordingly, the upper receiving groove 251 and the lower receiving groove 252 may form a step.

Oldham ring grooves in which an Oldham ring 70 is disposed may be formed on the bottom surface of the upper receiving groove 251. The Oldham ring grooves may be formed around the lower receiving groove 252.

The shaft support hole 22 may be formed on the bottom surface of the lower receiving groove 252. In other words, the lower receiving groove 252 may be in communication with the shaft support hole 22 of the protrusion 21. The lower receiving groove 252 may be formed to have a diameter greater than that of the shaft support hole 22. The lower receiving groove 252 may be formed concentrically with the shaft support hole 22.

A lower sealing groove 26 may be formed on the bottom surface of the receiving groove 25. In detail, the lower sealing groove 26 may be formed on the bottom surface of the lower receiving groove 252. The lower sealing groove 26 may be formed around the shaft support hole 22. The lower sealing groove 26 may be formed in an annular shape. The lower sealing groove 26 may be formed at a certain depth on the bottom surface of the lower receiving groove 252. For example, the cross-section of the lower receiving groove 252 may be formed in a U-shape with a flat bottom. A lower seal 73 may be disposed in the lower sealing groove 26.

A plurality of fixing holes 201 to which the fixed scroll 40 is fixed may be provided at the edge of the upper surface of the main frame 20. In detail, the plurality of fixing holes 201 may be formed around the upper receiving groove 251 on the upper surface of the main frame 20. Female threads may be formed on the inner surfaces of the plurality of fixing holes 201.

A plurality of first refrigerant passages 202 may be provided on the outer circumferential surface of the main frame 20. The plurality of first refrigerant passages 202 may be formed as grooves connecting the upper and lower surfaces of the main frame 20.

The fixed scroll 40 may be disposed on the upper surface of the main frame 20. The fixed scroll 40 may be disposed to cover the receiving groove 25 of the main frame 20. The fixed scroll 40 may be fixed to the plurality of fixing holes 201 on the upper surface of the main frame 20 with a plurality of bolts. The orbiting scroll 50 and the axially compliant frame 60 may be accommodated in a space formed by the fixed scroll 40 and the main frame 20.

The orbiting scroll 50 may be engaged with the fixed scroll 40 and may be disposed between the fixed scroll 40 and the main frame 20 so that the orbiting scroll 50 orbits with respect to the fixed scroll 40. The axially compliant frame 60 may be disposed below the orbiting scroll 50.

The fixed scroll 40 may include a wrap accommodation portion 41, a fixing portion 44 provided at the perimeter of the wrap accommodation portion 41, and a fixed wrap 43 provided in the inner space of the wrap accommodation portion 41.

The wrap accommodation portion 41 may be formed in a shape that is able to be accommodated inside the casing 10. The wrap accommodation portion 41 may be accommodated inside the casing 10 and may be formed in a substantially hollow cylindrical shape. For example, the wrap accommodation portion 41 may include a side wall having a cylindrical shape and an upper plate formed to block the upper end of the side wall.

The fixing portion 44 extending outward may be provided at the lower end of the wrap accommodation portion 41. The lower surface of the fixing portion 44, i.e., the surface in contact with a mirror plate 51 of the orbiting scroll 50 may form a thrust surface.

A plurality of through holes 441 for coupling with the main frame 20 may be provided at the edge of the fixing portion 44. Accordingly, the fixed scroll 40 may be fixed to the plurality of fixing holes 201 of the main frame 20 with the plurality of bolts inserted into the plurality of through holes 441 of the fixing portion 44.

In addition, a plurality of second refrigerant passages 442 may be provided at the edge of the fixing portion 44. The plurality of second refrigerant passages 442 may be formed as grooves connecting the upper and lower surfaces of the fixing portion 44. The plurality of second refrigerant passages 442 may be formed to correspond to the plurality of first refrigerant passages 202 of the main frame 20. The refrigerant discharged to the upper side of the fixed scroll 40 may move to the lower side of the main frame 20 through the plurality of first refrigerant passages 202 of the main frame 20 and the plurality of second refrigerant passages 442 of the fixed scroll 40.

The upper plate 41a of the wrap accommodation portion 41 may be formed in a circular plate shape, and may be provided with a discharge port 45 and a plurality of bypasses 49 through which refrigerant is discharged. A check valve configured to open and close the discharge port 45 and a plurality of bypass valves configured to open and close the plurality of bypasses 49 may be provided on the upper surface of the upper plate 41a.

A fixed mirror surface 41b may be formed on the lower surface of the upper plate 41a facing the orbiting scroll 50. Accordingly, the upper end of an orbiting wrap 52 of the orbiting scroll 50 may contact the fixed mirror surface 41b of the fixed scroll 40.

The fixed wrap 43 may be provided in the wrap accommodation portion 41. The fixed wrap 43 may extend vertically from the fixed mirror surface 41b of the wrap accommodation portion 41 and may be formed as a spiral-shaped curved surface having a certain thickness and height. For example, the fixed wrap 43 may be formed as an involute curve, an algebraic spiral curve, a hybrid curve, etc.

A spiral-shaped space may be formed in the inner space of the wrap accommodation portion 41 by the fixed wrap 43. The orbiting wrap 52 of the orbiting scroll 50 may be inserted into the spiral space of the wrap accommodation portion 41 of the fixed scroll 40.

The discharge port 45 may be formed at the center of the wrap accommodation portion 41 so as to penetrate the upper plate 41a of the wrap accommodation portion 41. In other words, the discharge port 45 may be formed adjacent to the center of the spiral space formed by the fixed wrap 43.

An inlet 46 through which refrigerant flows may be formed on a side surface of the fixed scroll 40. The inlet 46 may be connected to the refrigerant inlet pipe 13 disposed in the casing 10. Accordingly, the refrigerant introduced through the refrigerant inlet pipe 13 may be introduced into the inside of the fixed scroll 40 through the inlet 46. In detail, the inlet 46 may be formed to penetrate the side wall of the wrap accommodation portion 41. The inlet 46 may be formed adjacent to an outer end of the spiral space formed in the wrap accommodation portion 41. Accordingly, the refrigerant may be introduced into the spiral space of the fixed scroll 40 through the inlet 46.

An oil groove 47 may be formed on the lower surface of the fixed scroll 40, i.e., the thrust surface. The oil groove 47 may be formed at a certain depth on the thrust surface. For example, the cross-section of the oil groove 47 may be formed in a substantially U-shape with a flat bottom. The oil groove 47 may be formed in an arc shape surrounding the wrap accommodation portion 41.

The orbiting scroll 50 may be disposed below the fixed scroll 40 so as to be able to orbit with respect to the fixed scroll 40.

Referring to FIGS. 3 to 5, the orbiting scroll 50 may include a mirror plate 51, an orbiting wrap 52, and a boss 53.

The mirror plate 51 may be formed in a circular plate shape having a certain thickness and area. An orbiting mirror surface may be formed on the upper surface of the mirror plate 51 facing the fixed scroll 40.

The orbiting wrap 52 may extend vertically from the upper surface of the mirror plate 51, i.e., the orbiting mirror surface, and may be formed in a spiral shape. The orbiting wrap 52 may be formed to engage with the fixed wrap 43 of the fixed scroll 40.

The orbiting wrap 52 may be formed as a curved surface having a certain thickness and height. For example, the orbiting wrap 52 may be formed as an involute curve, an algebraic curve, a hybrid curve, etc.

The fixed wrap 43 of the fixed scroll 40 and the orbiting wrap 52 of the orbiting scroll 50 may be accommodated in the wrap accommodation portion 41 of the fixed scroll 40. The inner space 42 of the wrap accommodation portion 41 of the fixed scroll 40 may form a compression chamber.

The fixed wrap 43 and the orbiting wrap 52 engaged with each other may form the compression chamber, i.e., a plurality of compression pockets. When the orbiting scroll 50 rotates, the plurality of compression pockets may move to the center of the wrap accommodation portion 41, compressing the refrigerant drawn into the inlet 46 of the fixed scroll 40, and discharging the compressed refrigerant through the discharge port 45.

The mirror plate 51 may include a first intermediate pressure passage 58 and a second intermediate pressure passage 59 that connect the compression chamber, a first back pressure chamber B1, and a second back pressure chamber B2.

The first intermediate pressure passage 58 may be formed to connect the compression chamber and the first back pressure chamber B1. In other words, one end of the first intermediate pressure passage 58 may be formed to communicate with one of the plurality of compression pockets, and the other end thereof may be formed to communicate with the first back pressure chamber B1 formed between the orbiting scroll 50 and the axially compliant frame 60.

For example, the first intermediate pressure passage 58 may be formed to connect the upper and lower surfaces of the orbiting scroll 50. In other words, one end of the first intermediate pressure passage 58 may be formed on the upper surface of the mirror plate 51 of the orbiting scroll 50, and the other end thereof may be formed on the lower surface of the mirror plate 51. The hole connecting the two ends of the first intermediate pressure passage 58 may be formed inside the mirror plate 51.

The second intermediate pressure passage 59 may be formed to connect the compression chamber and the second back pressure chamber B2. In other words, one end of the second intermediate pressure passage 59 may be formed to communicate with one of the plurality of compression pockets, and the other end thereof may be formed to communicate with the second back pressure chamber B2 formed outside the axially compliant frame 60 between the orbiting scroll 50 and the upper receiving groove 251 of the main frame 20.

For example, the second intermediate pressure passage 59 may be formed to connect the upper and side surfaces of the orbiting scroll 50. In other words, one end of the second intermediate pressure passage 59 may be formed on the upper surface of the mirror plate 51 of the orbiting scroll 50, and the other end thereof may be formed on the side surface of the mirror plate 51. The hole connecting the two ends of the second intermediate pressure passage 59 may be formed inside the mirror plate 51.

The first intermediate pressure passage 58 may be formed to communicate with a compression pocket different from the compression pocket with which the second intermediate pressure passage 59 is communicated. The pressure of the compression pocket communicated with the first intermediate pressure passage 58 may be higher than the pressure of the compression pocket communicated with the second intermediate pressure passage 59. Therefore, the pressure of the refrigerant discharged into the first back pressure chamber B1 through the first intermediate pressure passage 58 may be higher than the pressure of the refrigerant discharged into the second back pressure chamber B2 through the second intermediate pressure passage 59.

The boss 53 may be formed at the center of the lower surface of the mirror plate 51 opposite to the orbital mirror surface. The boss 53 may be formed to extend downward from the lower surface of the mirror plate 51. The boss 53 may be formed in a hollow cylindrical shape. The upper end of the drive shaft 85 may be inserted into a hole 54 of the boss 53. In other words, an eccentric portion 87 provided at the upper end 87 of the drive shaft 85 may be coupled to the boss 53.

A bearing 55 may be disposed in the hole 54 of the boss 53. The bearing 55 may be formed of bearing metal. Therefore, when the drive shaft 85 rotates, the orbiting scroll 50 may rotate.

A flange 531 may be formed at the lower end of the boss 53. The flange 531 may be formed parallel to the mirror plate 51. The flange 531 may be formed to protrude outward from the outer circumferential surface of the boss 53. The flange 531 may be formed in an annular shape and may have a diameter smaller than the diameter of the lower receiving groove 252.

The orbiting wrap 52 of the orbiting scroll 50 may engage with the fixed wrap 43 of the fixed scroll 40, and the boss 53 may be inserted into the receiving groove 25 of the main frame 20. In detail, the mirror plate 51 of the orbiting scroll 50 may be positioned in the upper receiving groove 251, and the flange 531 of the boss 53 may be positioned in the lower receiving groove 252.

In addition, the lower surface of the mirror plate 51 on which the boss 53 is formed may be supported by the axially compliant frame 60. In detail, the lower surface of the mirror plate 51 may be supported by the upper surface of the axially compliant frame 60 into which the boss 53 is inserted.

A lower seal 73 may be disposed between the flange 531 of the boss 53 and the bottom surface of the receiving groove 25. In detail, the lower seal 73 may be disposed between the bottom surface of the lower receiving groove 252 and the flange 531 of the boss 53. In other words, the flange 531 of the boss 53 may be supported by the lower seal 73 disposed in the lower sealing groove 26. Therefore, the boss hole 54 and the outer side of the boss 53, i.e., the receiving groove 25 of the main frame 20, may be isolated by the lower seal 73. In other words, the hole 54 of the boss 53 and the lower receiving groove 252 of the main frame 20 may be blocked from communicating with each other by the lower seal 73.

The axially compliant frame 60 may be disposed on the lower side of the orbiting scroll 50. The axially compliant frame 60 may be disposed on the lower side of the orbiting scroll 50 in the receiving groove 25 of the main frame 20 so as to be movable up and down relative to the orbiting scroll 50. In other words, the axially compliant frame 60 may be disposed to move axially in the receiving groove 25 of the main frame 20. The axially compliant frame 60 may be configured to divide the receiving groove 25 of the main frame 20 into the first back pressure chamber B1 and the second back pressure chamber B2.

The axially compliant frame 60 may be formed in a hollow cylindrical shape. The boss 53 of the orbiting scroll 50 may be inserted into the axially compliant frame 60. A through hole 65 may be formed at the center of the axially compliant frame 60, and the outer circumferential surface of the axially compliant frame 60 may be formed to have a step.

The first back pressure chamber B1 may be located on the inner side of the axially compliant frame 60, and the second back pressure chamber B2 may be located on the outer side of the axially compliant frame 60. In detail, the first back pressure chamber B1 may be formed in the space between the boss 53 of the orbiting scroll 50 and the axially compliant frame 60. The second back pressure chamber B2 may be formed in the space between the inner circumferential surface of the receiving groove 25 of the main frame 20, the orbiting scroll 50, and the axially compliant frame 60.

A first seal 71 may be disposed between the axially compliant frame 60 and the orbiting scroll 50. In detail, the first seal 71 may be disposed between the upper surface of the axially compliant frame 60 and the lower surface of the mirror plate 51 of the orbiting scroll 50. The first seal 71 may be formed of Teflon.

A second seal 72 may be disposed between the axially compliant frame 60 and the main frame 20. In detail, the second seal 72 may be disposed between the outer circumferential surface of the axially compliant frame 60 and the inner circumferential surface of the lower receiving groove 252 of the main frame 20. The second seal 72 may be formed of an O-ring.

Therefore, the first back pressure chamber B1 and the second back pressure chamber B2 may be isolated by the first seal 71 disposed between the upper surface of the axially compliant frame 60 and the lower surface of the orbiting scroll 50 and the second seal 72 between the outer circumferential surface of the axially compliant frame 60 and the main frame 20. In other words, the first back pressure chamber B1 and the second back pressure chamber B2 may be blocked by the first seal 71 and the second seal 72 and may not communicate with each other.

The drive motor 80 may include a stator 81 and a rotor 82. The stator 81 may be fixed to the inner surface of the casing 10. The rotor 82 may be rotatably disposed inside the stator 81.

In addition, the drive shaft 85 may be inserted through the rotor 82. Because the rotor 82 is fixed to the drive shaft 85, the rotor 82 and the drive shaft 85 may rotate as one body.

The drive shaft 85 may include a shaft portion 86 formed to have a certain length and an eccentric portion 87 extending upward from an upper end of the shaft portion 86. The central axis of the eccentric portion 87 may be spaced apart by a certain distance from the rotation center of the drive shaft 85, i.e., the central axis of the shaft portion 86.

The rotor 82 of the drive motor 80 may be fixed to the shaft portion 86 of the drive shaft 85. One end of the shaft portion 86 may be inserted into the shaft support hole 22 of the protrusion 21 of the main frame 20 and may be rotatably supported by the bearing 23 disposed in the shaft support hole 22.

The upper end of the drive shaft 85, i.e., the eccentric portion 87, may be inserted into the hole 54 of the boss 53 of the orbiting scroll 50. The eccentric portion 87 of the drive shaft 85 may be supported by the bearing 55 disposed in the boss 53 of the orbiting scroll 50.

A balance weight 84 may be disposed on the shaft portion 86 of the drive shaft 85 above the rotor 82. In other words, the balance weight 84 may be disposed on the shaft portion 86 between the rotor 82 and the main frame 20.

A lower portion of the shaft portion 86 may be supported by a bearing 31 disposed on the sub frame 30 fixed to the casing 10. The bearing 31 of the sub frame 30 may be formed of bearing metal. Accordingly, the drive shaft 85 may rotate while being supported at both ends thereof by the main frame 20 and the sub frame 30.

In addition, the drive shaft 85 may be provided with an oil passage 88 that penetrates the shaft portion 86 and the eccentric portion 87. An outlet 88a of the oil passage 88 may be provided at an upper end of the eccentric portion 87. Therefore, oil flowing along the oil passage 88 may be discharged to the hole 54 of the boss 53 of the orbiting scroll 50. In other words, the oil that has moved through the oil passage 88 may be discharged into the space of the hole 54 of the boss 53 on the upper side of the eccentric portion 87 of the drive shaft 85.

An oil pump 33 for supplying oil from the oil reservoir 15 to the oil passage 88 may be disposed at the lower end of the drive shaft 85. The lower end of the oil pump 33 may be submerged in the oil reservoir 15 of the casing 10.

Therefore, when the drive shaft 85 rotates, the oil stored in the oil reservoir 15 may be supplied to the oil passage 88 of the drive shaft 85 by the pressure applied to the oil reservoir 15 and the oil pump 33.

The oil moving along the oil passage 88 may be supplied to the hole 54 of the boss 53 of the orbiting scroll 50 through the outlet 88a. In addition, a portion of the oil moving through the oil passage 88 may be supplied to the bearing 23 of the main frame 20 through a side outlet of the oil passage 88.

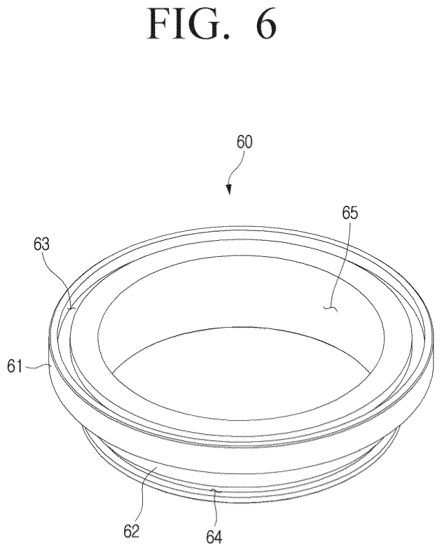

Hereinafter, the axially compliant frame 60 will be described in detail with reference to FIGS. 3 and 6.

FIG. 6 is a perspective view illustrating an axially compliant frame 60 of a scroll compressor according to one or more embodiments of the disclosure.

Referring to FIGS. 3 and 6, the axially compliant frame 60 may be formed in a hollow cylindrical shape. The axially compliant frame 60 may include an upper sleeve 61 and a lower sleeve 62.

The upper sleeve 61 may be formed in a hollow cylindrical shape. The lower sleeve 62 may be extend from the lower surface of the upper sleeve 61 and may be formed in a hollow cylindrical shape with a smaller outer diameter than the upper sleeve 61. The lower sleeve 62 may be formed in a hollow cylindrical shape with an inner diameter identical to that of the hollow of the upper sleeve 61. Therefore, the upper sleeve 61 and the lower sleeve 62 may form a step. In other words, a through hole 65 without a step may be formed in the center of the axially compliant frame 60, and the outer circumferential surface of the axially compliant frame 60 may form a step.

The axially compliant frame 60 may move upward by the refrigerant flowing into the first back pressure chamber B1. The axially compliant frame 60 may move downward by the orbiting scroll 50. In detail, when the pressure applied to the upper surface of the mirror plate 51 of the orbiting scroll 50 is greater than the pressure applied to the lower surface of the mirror plate 51, the orbiting scroll 50 may move downward, and the axially compliant frame 60 may be moved downward by the orbiting scroll 50. For example, when liquid refrigerant flows into the compression chamber formed by the fixed scroll 40 and the orbiting scroll 50, the axially compliant frame 60 may be moved downward by the orbiting scroll 50.

The axially compliant frame 60 may include a first sealing groove 63 and a second sealing groove 64. The first sealing groove 63 may be formed on the upper surface of the axially compliant frame 60, and the second sealing groove 64 may be formed on the lower portion of the outer circumferential surface of the axially compliant frame 60.

In detail, the first sealing groove 63 may be formed at a certain depth on the upper surface of the upper sleeve 61. The cross-section of the first sealing groove 63 may be formed in a roughly U-shape with a flat bottom. The first sealing groove 63 may be formed around the through hole 65 of the axially compliant frame 60. The first sealing groove 63 and the through hole 65 may be formed concentrically.

The second sealing groove 64 may be formed at a certain depth on the outer circumferential surface of the lower sleeve 62. The cross-section of the second sealing groove 64 may be formed in a roughly U-shape with a flat bottom. The second sealing groove 64 may be formed adjacent to the lower end of the lower sleeve 62. The second sealing groove 64 may be formed along the entire perimeter of the outer circumferential surface of the lower sleeve 62.

The first seal 71 may be disposed in the first sealing groove 63, and the second seal 72 may be disposed in the second sealing groove 64.

The first back pressure chamber B1 may be formed as a space between the inner circumferential surface of the axially compliant frame 60 and the orbiting scroll 50. The second back pressure chamber B2 may be formed as a space between the outer circumferential surface of the axially compliant frame 60, the orbiting scroll 50, and the inner circumferential surface of the receiving groove 25 of the main frame 20. The first back pressure chamber B1 and the second back pressure chamber B2 may not be communicated with each other by the first seal 71 and the second seal 72 disposed in the first sealing groove 63 and the second sealing groove 64 of the axially compliant frame 60.

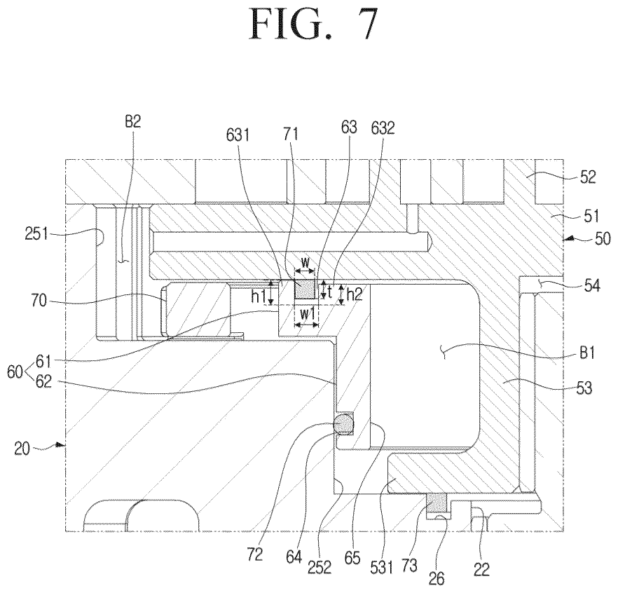

Hereinafter, the first seal 71 and the second seal 72 disposed in the first sealing groove 63 and the second sealing groove 64 of the axially compliant frame 60 will be described in detail with reference to FIG. 7.

FIG. 7 is an enlarged cross-sectional view illustrating portion A of FIG. 3.

Referring to FIG. 7, the axially compliant frame 60 may be disposed below the orbiting scroll 50. The boss 53 of the orbiting scroll 50 may be inserted into the axially compliant frame 60, so that the axially compliant frame 60 is able to support the mirror plate 51 of the orbiting scroll 50.

The lower sleeve 62 of the axially compliant frame 60 may be inserted into the lower receiving groove 252 of the main frame 20, and the upper sleeve 61 of the axially compliant frame 60 may be positioned in the upper receiving groove 251. In other words, because the outer diameter of the upper sleeve 61 is larger than the inner diameter of the lower receiving groove 252 of the main frame 20, the upper sleeve 61 may not be inserted into the lower receiving groove 252. Therefore, the lower surface of the upper sleeve 61 may be supported by the bottom surface of the upper receiving groove 251 of the main frame 20.

Therefore, the space between the outer circumferential surface of the boss 53 of the orbiting scroll 50 and the inner circumferential surface of the axially compliant frame 60 may form the first back pressure chamber B1. The upper end of the first back pressure chamber B1 may be blocked by the mirror plate 51 of the orbiting scroll 50, and the lower end of the first back pressure chamber B1 may be blocked by the bottom surface of the lower receiving groove 252 of the main frame 20.

The space between the inner circumferential surface of the upper receiving groove 251 of the main frame 20, the outer circumferential surface of the mirror plate 51 of the orbiting scroll 50, and the outer circumferential surface of the axially compliant frame 60 may form the second back pressure chamber B2. The upper end of the second back pressure chamber B2 may be blocked by the fixed scroll 40, and the lower end of the second back pressure chamber B2 may be blocked by the bottom surface of the upper receiving groove 251 of the main frame 20.

The Oldham ring 70 may be disposed outside the axially compliant frame 60 in the second back pressure chamber B2.

The first back pressure chamber B1 and the second back pressure chamber B2 may be isolated from each other by the first seal 71 and the second seal 72 and may not be in communication with each other.

For example, the first seal 71 may be interposed between the lower surface of the mirror plate 51 of the orbiting scroll 50 and the upper surface of the axially compliant frame 60. In detail, the first seal 71 may be disposed in the first sealing groove 63 formed on the upper surface of the axially compliant frame 60.

The first sealing groove 63 may include an outer wall 631 and an inner wall 632. The height h1 of the outer wall 631 and the height h2 of the inner wall 632 may be formed differently. In the case of the first sealing groove 63 illustrated in FIG. 7, the height h1 of the outer wall 631 may be higher than the height h2 of the inner wall 632 (h1>h2). Therefore, when the upper end of the outer wall 631 of the first sealing groove 63 comes into contact with the lower surface of the mirror plate 51 of the orbiting scroll 50, the upper end of the inner wall 632 may not come into contact with the lower surface of the mirror plate 51. In addition, the height h1 of the outer wall 631 may be formed to be greater than the thickness t of the first seal 71 (h1>t).

In addition, the width w1 of the first sealing groove 63 may be formed to be greater than the width w of the first seal 71. Therefore, when the first seal 71 is disposed in the first sealing groove 63, a gap may be exist between the first sealing groove 63 and the first seal 71.

When the scroll compressor 1 operates and refrigerant is supplied to the first back pressure chamber B1, the refrigerant in the first back pressure chamber B1 may flow into the first sealing groove 63 through the gap between the lower surface of the mirror plate 51 of the orbiting scroll 50 and the upper end of the inner wall 632 of the axially compliant frame 60. When the refrigerant flows into the first sealing groove 63, the first seal 71 rises, and the outer circumferential surface and the upper surface of the first seal 71 may come into contact with the outer wall 631 of the first sealing groove 63 and the lower surface of the mirror plate 51. Therefore, the refrigerant in the first back pressure chamber B1 may not flow into the second back pressure chamber B2 between the first seal 71 and the mirror plate 51 of the orbiting scroll 50. At this time, the pressure Pm1 of the first back pressure chamber B1 may be greater than the pressure Pm2 of the second back pressure chamber B2 (Pm1>Pm2). The pressure Pm2 of the second back pressure chamber B2 may be greater than the inflow pressure Ps of the refrigerant flowing into the fixed scroll 40 (Pm2>Ps).

The second seal 72 may be interposed between the inner circumferential surface of the lower receiving groove 252 of the main frame 20 and the outer circumferential surface of the lower sleeve 62 of the axially compliant frame 60. In detail, the second seal 72 may be disposed in the second sealing groove 64 formed on the outer circumferential surface of the lower sleeve 62.

Because the depth of the second sealing groove 64 is lower than the height of the second seal 72, the second seal 72 may protrude from the second sealing groove 64 and may always be in contact with the inner circumferential surface of the lower receiving groove 252. In other words, the gap between the outer circumferential surface of the lower sleeve 62 of the axially compliant frame 60 and the inner circumferential surface of the lower receiving groove 252 of the main frame 20 may be blocked by the second seal 72. Therefore, the refrigerant in the first back pressure chamber B1 may not flow into the second back pressure chamber B2 through the gap between the outer circumferential surface of the lower sleeve 62 and the inner circumferential surface of the lower receiving groove 252 of the main frame 20.

The lower seal 73 may be interposed between the bottom surface of the lower receiving groove 252 of the main frame 20 and the lower surface of the boss 53 of the orbiting scroll 50. In detail, the lower seal 73 may be disposed in the lower sealing groove 26 formed on the bottom surface of the lower receiving groove 252.

The gap between the first back pressure chamber B1 and the hole 54 of the boss 53 of the orbiting scroll 50 may be blocked by the lower seal 73. Therefore, the discharged refrigerant flowing into the hole 54 of the boss 53 may not flow into the first back pressure chamber B1 through the gap between the bottom surface of the lower receiving groove 252 and the flange 531 of the boss 53.

At this time, the pressure Pd of the hole 54 of the boss 53 filled with the discharged refrigerant may be greater than the pressure Pm1 of the first back pressure chamber B1 (Pd>Pm1). Therefore, the pressure Pd of the hole 54 of the boss 53 is the highest, and the suction pressure Ps may be lowest. In other words, Pd>Pm1>Pm2>Ps.

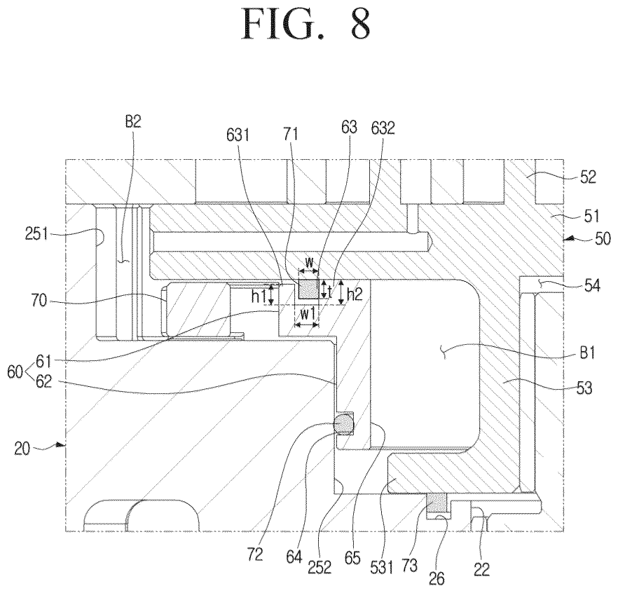

As another example, the height of the outer wall 631 of the first sealing groove 63 may be formed to be smaller than the height of the inner wall 632. This will be described below with reference to FIG. 8.

FIG. 8 is a partial cross-sectional view illustrating an orbiting scroll 50 and an axially compliant frame 60 of a scroll compressor 1 according to one or more embodiments of the disclosure.

Referring to FIG. 8, the space between the outer circumferential surface of the boss 53 of the orbiting scroll 50 and the inner circumferential surface of the axially compliant frame 60 may form the first back pressure chamber B1. The upper end of the first back pressure chamber B1 may be blocked by the mirror plate 51 of the orbiting scroll 50, and the lower end of the first back pressure chamber B1 may be blocked by the bottom surface of the lower receiving groove 252 of the main frame 20.

The space between the inner circumferential surface of the upper receiving groove 251 of the main frame 20, the outer circumferential surface of the mirror plate 51 of the orbiting scroll 50, and the outer circumferential surface of the axially compliant frame 60 may form the second back pressure chamber B2. The end of the second back pressure chamber B2 may be blocked by the fixed scroll 40, and the lower end of the second back pressure chamber B2 may be blocked by the bottom surface of the upper receiving groove 251 of the main frame 20.

In this embodiment, the pressure Pm2 of the second back pressure chamber B2 may be formed to be greater than the pressure Pm1 of the first back pressure chamber B1. In other words, the first intermediate pressure passage 58 and the second intermediate pressure passage 59 may be formed so that the pressure of the refrigerant supplied to the second back pressure chamber B2 is greater than the pressure of the refrigerant supplied to the first back pressure chamber B1.

The first back pressure chamber B1 and the second back pressure chamber B2 may be isolated from each other by the first seal 71 and the second seal 72 and may not be in communication with each other.

For example, the first seal 71 may be interposed between the lower surface of the mirror plate 51 of the orbiting scroll 50 and the upper surface of the axially compliant frame 60. In detail, the first seal 71 may be disposed in the first sealing groove 63 formed on the upper surface of the axially compliant frame 60.

The first sealing groove 63 may include an outer wall 631 and an inner wall 632. The height h1 of the outer wall 631 and the height h2 of the inner wall 632 may be formed differently. In the case of the first sealing groove 63 illustrated in FIG. 8, the height h1 of the outer wall 631 may be lower than the height h2 of the inner wall 632 (h1<h2). Therefore, when the upper end of the inner wall 632 of the first sealing groove 63 comes into contact with the lower surface of the mirror plate 51 of the orbiting scroll 50, the upper end of the outer wall 631 may not come into contact with the lower surface of the mirror plate 51. In addition, the height h2 of the inner wall 632 may be formed to be greater than the thickness t of the first seal 71 (h2>t).

In addition, the width w1 of the first sealing groove 63 may be formed to be greater than the width w of the first seal 71. Therefore, when the first seal 71 is disposed in the first sealing groove 63, a gap may be exist between the first sealing groove 63 and the first seal 71.

When the scroll compressor 1 operates and refrigerant is supplied to the second back pressure chamber B2, the refrigerant in the second back pressure chamber B2 may flow into the first sealing groove 63 through the gap between the lower surface of the mirror plate 51 of the orbiting scroll 50 and the upper end of the outer wall 631 of the axially compliant frame 60. When the refrigerant flows into the first sealing groove 63, the first seal 71 rises, and the inner circumferential surface and the upper surface of the first seal 71 may come into contact with the inner wall 632 of the first sealing groove 63 and the lower surface of the mirror plate 51. Therefore, the refrigerant in the second back pressure chamber B2 may not flow into the first back pressure chamber B1 between the first seal 71 and the mirror plate 51 of the orbiting scroll 50. At this time, the pressure Pm2 of the second back pressure chamber B2 may be greater than the pressure Pm1 of the first back pressure chamber B1 (Pm1>Pm2). The pressure Pm1 of the first back pressure chamber B1 may be greater than the inflow pressure Ps of the refrigerant flowing into the fixed scroll 40 (Pm1>Ps).

The structures of the second sealing groove 64 and the lower sealing groove 26 may be identical to those of the above-described embodiment, and therefore, detailed descriptions thereof are omitted.

Therefore, in this embodiment, the pressure Pd of the hole 54 of the boss 53 may be the greatest, and the suction pressure Ps may be lowest. In other words, Pd>Pm2>Pm1>Ps.

Hereinafter, a pressure distribution of a scroll compressor 1 according to one or more embodiments of the disclosure will be compared and described with respect to a pressure distribution of a scroll compressor 100 according to the prior art.

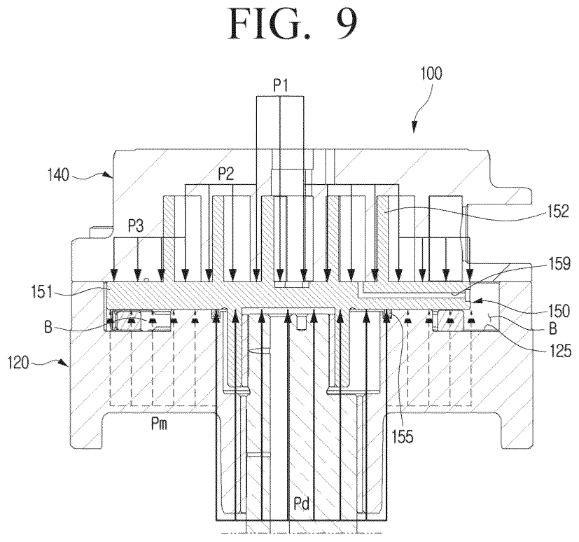

FIG. 9 is a diagram illustrating a pressure distribution in an orbiting scroll 150 of a scroll compressor 100 according to the prior art.

In the scroll compressor 100 according to the prior art, the highest pressure may be applied to the center of the upper surface of the orbiting scroll 150, and the lowest pressure may be applied to the edge thereof. This may be because the plurality of compression pockets formed by the fixed scroll 140 and the orbiting scroll 150 compress and discharge the refrigerant while moving toward the center by the rotation of the orbiting scroll 150.

Simplifying the pressure applied to the upper surface of the orbiting scroll 150, as illustrated in FIG. 9, pressures having approximately three magnitudes may be applied to the upper surface of the orbiting scroll 150. In other words, the maximum pressure P1 may be applied to the center portion of the upper surface of the orbiting scroll 150 corresponding to the discharge port, the intermediate pressure P2 may be applied to the inside of the orbiting wrap 52 of the upper surface of the orbiting scroll 50, and the minimum pressure P3 may be applied to the edge of the upper surface of the orbiting scroll 150.

A back pressure chamber B may be provided on the lower surface of the orbiting scroll 150. The back pressure chamber B may be formed in the inner space of a receiving groove 125 of the main frame 120 outside the seal 155. The back pressure chamber B may be communicated with the compression chamber on the upper side of the orbiting scroll 150 by an intermediate pressure passage 159. Accordingly, because intermediate pressure refrigerant is supplied to the back pressure chamber B through the intermediate pressure passage 159, intermediate pressure may be applied to the back pressure chamber B.

Referring to FIG. 9, two pressures may be applied to the lower surface of the orbiting scroll 150. In other words, a discharge pressure Pd may be applied to the space inside the seal 155, and an intermediate pressure Pm may be applied to the back pressure chamber B outside the seal 155. The discharge pressure Pd and the intermediate pressure Pm may correspond to the maximum pressure P1 and intermediate pressure P2 applied to the upper surface of the orbiting scroll 150. Therefore, in the scroll compressor 100 according to the prior art, the pressure distribution applied to the upper surface of the orbiting scroll 150 may differ from the pressure distribution applied to the lower surface of the orbiting scroll 150.

As a result, in the scroll compressor 100 according to the prior art, frictional losses in components may increase or axial refrigerant leakage may occur under conditions where the cooling load is greater or less than the reference cooling load.

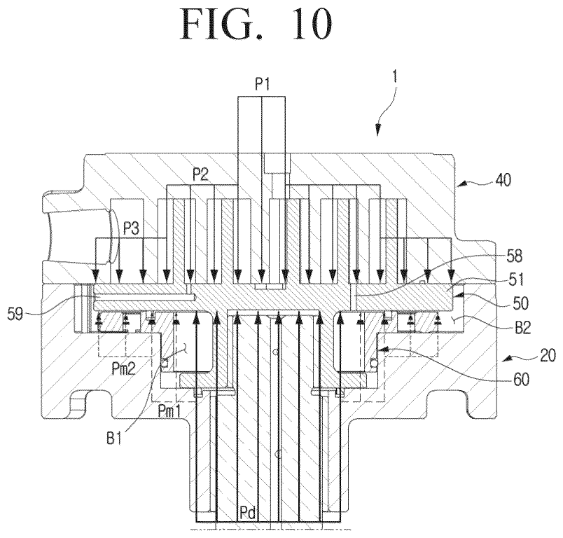

FIG. 10 is a diagram illustrating a pressure distribution in an orbiting scroll 50 of a scroll compressor 1 according to one or more embodiments of the disclosure.

In the scroll compressor 1 according to one or more embodiments of the disclosure, the greatest pressure may be applied to the center of the upper surface of the orbiting scroll 50, and the least pressure may be applied to the edge thereof. In other words, pressure may be applied to the upper surface of the orbiting scroll 50 in the same manner as in the prior art.

Simplifying the pressure applied to the upper surface of the orbiting scroll 50, as illustrated in FIG. 10, pressures having approximately three magnitudes may be applied to the upper surface of the orbiting scroll 50. In other words, the maximum pressure P1 may be applied to the center portion of the upper surface of the orbiting scroll 50 corresponding to the discharge port, the intermediate pressure P2 may be applied to the inside of the orbiting wrap 52 of the upper surface of the orbiting scroll 50, and the minimum pressure P3 may be applied to the edge of the upper surface of the orbiting scroll 50.

Two back pressure chambers, i.e., a first back pressure chamber B1 and a second back pressure chamber B2, may be provided on the lower surface of the orbiting scroll 50. Refrigerant having different pressures may be supplied to the first back pressure chamber B1 and the second back pressure chamber B2. For example, the first back pressure chamber B1 may be communicated with a compression pocket adjacent to the center portion of the orbiting scroll 50 through a first intermediate pressure passage 58. The second back pressure chamber B2 may be communicated with a compression pocket adjacent to the edge of the orbiting scroll 50 through a second intermediate pressure passage 59. Therefore, the pressure of the first back pressure chamber B1 may be higher than the pressure of the second back pressure chamber B2.

Accordingly, in the scroll compressor 1 according to one or more embodiments of the disclosure, pressures having three magnitudes may be applied to the lower surface of the orbiting scroll 50. In other words, the discharge pressure Pd may be applied to the hole 54 of the boss 53 on the lower surface of the orbiting scroll 50, the first intermediate pressure Pm1 may be applied to the first back pressure chamber B1, and the second intermediate pressure Pm2 may be applied to the second back pressure chamber B2. The discharge pressure Pd may correspond to the maximum pressure P1 applied to the upper surface of the orbiting scroll 50. The first intermediate pressure Pm1 and the second intermediate pressure Pm2 may correspond to the intermediate pressure P2 and the minimum pressure P3 applied to the upper surface of the orbiting scroll 50. The first intermediate pressure Pm1 and the second intermediate pressure Pm2 may not be identical to the intermediate pressure P2 and the minimum pressure P3 applied to the upper surface, but the difference between them is not significant.

Therefore, the scroll compressor 1 according to one or more embodiments of the disclosure may have the pressure distribution applied to the lower surface of the orbiting scroll 50 similar to the pressure distribution applied to the upper surface of the orbiting scroll 50. Accordingly, the scroll compressor 1 according to one or more embodiments of the disclosure may reduce friction losses of components and axial refrigerant leakage of the scroll compressor 1 when the cooling load is greater or less than the reference cooling load, compared to the scroll compressor 100 according to the prior art.

In detail, in the scroll compressor 1 according to one or more embodiments of the disclosure, under conditions where the cooling load is less than the reference cooling load, the difference in pressure applied to the upper and lower surfaces of the orbiting scroll 50 may be smaller than that of the scroll compressor 100 according to the prior art. Therefore, axial refrigerant leakage that may occur due to the orbiting scroll 50 overturning may be reduced.

In addition, in the scroll compressor 1 according to one or more embodiments of the disclosure, the difference in pressure applied to the upper and lower surfaces of the orbiting scroll 50 may be smaller than that of the scroll compressor 100 according to the prior art. Accordingly, frictional losses of components of the scroll compressor 1 that may occur due to contact between the fixed scroll 40 and the orbiting scroll 50 may be minimized.

In addition, the scroll compressor 1 according to one or more embodiments of the disclosure may be configured such that the axially compliant frame 60 disposed on the lower side of the orbiting scroll 50 may move up and down relative to the orbiting scroll 50. Therefore, the gap between the mirror surface of the fixed scroll 40 and the upper surface of the mirror plate 51 of the orbiting scroll 50 may be made larger than that of the scroll compressor 100 according to the prior art. Accordingly, in the scroll compressor 1 according to one or more embodiments of the disclosure, when liquid refrigerant is introduced into the compression chamber, the liquid refrigerant may cause the orbiting scroll 50 to move downward, allowing the liquid refrigerant to be quickly discharged between the fixed scroll 40 and the orbiting scroll 50.

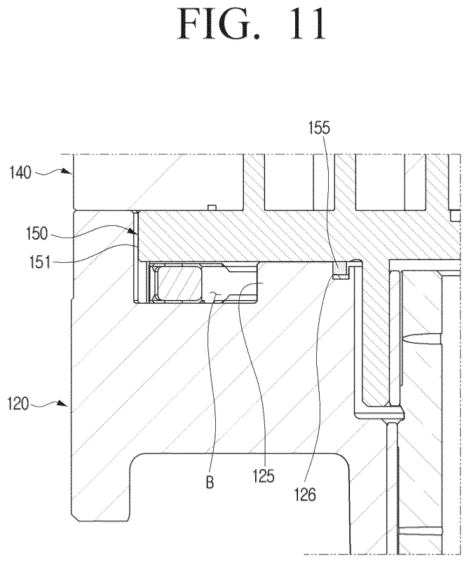

FIG. 11 is a partial cross-sectional view illustrating a back pressure chamber B of the scroll compressor 100 according to the prior art.

Referring to FIG. 11, in the scroll compressor 100 according to the prior art, a mirror plate 151 of the orbiting scroll 150 may be positioned between the lower surface of the fixed scroll 40 and the support portion 125 of the main frame 20. A seal 155 may be interposed between the lower surface of the mirror plate 51 of the orbiting scroll 50 and the support portion 125 of the main frame 120. The seal 155 may be disposed in a sealing groove 126 formed on the upper surface of the support portion 125.

When the scroll compressor 100 operates, the upper surface of the mirror plate 151 of the orbiting scroll 150 may contact the lower surface of the fixed scroll 140, and the lower surface of the mirror plate 151 may be supported by the seal 155 disposed on the support portion 125 of the main frame 120.

Because the liquid refrigerant is not compressible, when the scroll compressor 100 is operating, as the liquid refrigerant flows into the inside of the fixed scroll 140, the fixed wrap of the fixed scroll 140 and the orbiting wrap of the orbiting scroll 150 may be damaged. Therefore, when the liquid refrigerant flows into the inside of the fixed scroll 140, it is necessary to ensure that the liquid refrigerant is quickly discharged between the fixed scroll 140 and the orbiting scroll 150.

As illustrated in FIG. 11, in the scroll compressor 100 according to the prior art, the support portion 125 of the main frame 120 is positioned below the orbiting scroll 150, so the gap through which the orbiting scroll 150 can move downward by the liquid refrigerant may be very small. Therefore, when the liquid refrigerant flows into the fixed scroll 140, it may take a long time for the liquid refrigerant to be discharged, which may damage the fixed wrap of the fixed scroll 140 and the orbiting wrap of the orbiting scroll 150.

However, in the scroll compressor 1 according to one or more embodiments of the disclosure, the axially compliant frame 60 is axially movable in the receiving groove 25 of the main frame 20, so that the gap through which the orbiting scroll 50 can move downward may be large. In other words, the gap at which the orbiting scroll 50 can move downward by the gap at which the axially compliant frame 60 can move up and down may be greater than the gap at which the orbiting scroll 150 of the scroll compressor 100 according to the prior art can move.

Therefore, when the liquid refrigerant flows into the fixed scroll 40, the orbiting scroll 50 may move downward due to the liquid refrigerant, and the axially compliant frame 60 may move downward due to the orbiting scroll 50, thereby increasing the gap between the fixed scroll 40 and the orbiting scroll 50. Accordingly, the liquid refrigerant inside the fixed scroll 40 may be quickly discharged through the large gap formed between the fixed scroll 40 and the orbiting scroll 50. Therefore, the scroll compressor 1 according to one or more embodiments of the disclosure may quickly discharge the liquid refrigerant inside the fixed scroll 40, thereby preventing or minimizing damage to fixed wrap 43 of the fixed scroll 40 and the orbiting wrap 52 of the orbiting scroll 50.

Therefore, the scroll compressor 1 according to one or more embodiments of the disclosure having the above-described structure may reduce friction loss and axial refrigerant leakage.

In the foregoing, the disclosure has been shown and described with reference to various embodiments. However, it is understood by those skilled in the art that various changes may be made in form and detail without departing from the scope of the disclosure as defined by the appended claims and equivalents thereof.

1. A scroll compressor comprising:
a casing;
a main frame, fixable inside the casing, comprising a receiving groove that is formed on an upper surface of the main frame;
a fixed scroll arrangeable on the upper surface of the main frame;
an orbiting scroll arrangeable in the receiving groove of the main frame such that while the orbiting scroll is arranged in the receiving groove, the orbiting scroll is engaged with the fixed scroll to form a compression chamber;
an axially compliant frame arrangeable in the receiving groove of the main frame such that while the axially compliant frame is arranged in the receiving groove, the axially compliant frame is at a lower side of the orbiting scroll and the axially compliant frame is moveable relative to the lower side of the orbiting scroll, the axially compliant frame being configured to divide the receiving groove into a first back pressure chamber and a second back pressure chamber;
a drive shaft, coupleable to a lower portion of the orbiting scroll, configured to rotate the orbiting scroll; and
a drive motor, arrangeable below the main frame, configured to rotate the drive shaft.

2. The scroll compressor of claim 1, wherein
the first back pressure chamber is located inside the axially compliant frame, and
the second back pressure chamber is located outside the axially compliant frame.

3. The scroll compressor of claim 2, wherein
the first back pressure chamber and the second back pressure chamber are isolated from each other by a first seal between an upper surface of the axially compliant frame and a lower surface of the orbiting scroll at the lower side of the orbiting scroll, and a second seal between an outer circumferential surface of the axially compliant frame and the main frame.

4. The scroll compressor of claim 3, wherein
the axially compliant frame comprises:
a first sealing groove formed on the upper surface of the axially compliant frame to accommodate the first seal; and
a second seal groove formed on the outer circumferential surface of the axially compliant frame to accommodate the second seal.

5. The scroll compressor of claim 4, wherein
the first sealing groove has a height of an inner wall in contact with the first back pressure chamber lower than a height of an outer wall in contact with the second back pressure chamber.

6. The scroll compressor of claim 4, wherein
the first sealing groove has a height of an outer wall in contact with the second back pressure chamber lower than a height of an inner wall in contact with the first back pressure chamber.

7. The scroll compressor of claim 2, wherein
the orbiting scroll comprises:
a first intermediate pressure passage connecting the compression chamber and the first back pressure chamber; and
a second intermediate pressure passage connecting the compression chamber and the second back pressure chamber.

8. The scroll compressor of claim 7, wherein
the first intermediate pressure passage is formed to connect the upper surface of a lower surface of the orbiting scroll at the lower side of the orbiting scroll.

9. The scroll compressor of claim 7, wherein
the second intermediate pressure passage is formed to connect the upper surface and a side surface of the orbiting scroll.

10. The scroll compressor of claim 1, wherein
the main frame comprises an Oldham ring disposed in the receiving groove of the main frame on the lower side of the orbiting scroll, and
wherein the Oldham ring is disposed on an outer side of the axially compliant frame.

11. The scroll compressor of claim 1, wherein
a pressure of the first back pressure chamber is greater than a pressure of the second back pressure chamber.

12. The scroll compressor of claim 1, wherein
the axially compliant frame comprises:
an upper sleeve formed in a hollow cylindrical shape; and
a lower sleeve, formed in a hollow cylindrical shape extending from a lower surface of the upper sleeve, having an outer diameter smaller than an outer diameter of the upper sleeve and an inner diameter equal to an inner diameter of the upper sleeve,
wherein a first seal is disposed on an upper surface of the upper sleeve, and a second seal is disposed on an outer circumferential surface of the lower sleeve.

13. The scroll compressor of claim 12, wherein
the first back pressure chamber is formed as a space between the orbiting scroll and an inner circumferential surface of the axially compliant frame, and
the second back pressure chamber is formed as a space between the orbiting scroll, the receiving groove of the main frame, and an outer circumferential surface of the axially compliant frame.

14. The scroll compressor of claim 12, wherein
the receiving groove of the main frame comprises:
an upper receiving groove in which the upper sleeve is received; and
a lower receiving groove formed on a bottom surface of the upper receiving groove to have a smaller diameter than the upper receiving groove and in which the lower sleeve is received.

15. The scroll compressor of claim 1, further comprising:
a lower seal between a lower surface of the orbiting scroll at the lower side of the orbiting scroll and a bottom surface of the receiving groove of the main frame.
